(19) United States
(12) Patent Application Publication
(10) Pub. No.: US 2026/0096689 A1
(43) Pub. Date: Apr. 9, 2026

(54) DEVICE FOR FILTRATION AND TRANSPORTATION OF USED COOKING OIL

(71) Applicant: Brian Terando, Leominster, MA (US)

(72) Inventor: Brian Terando, Leominster, MA (US)

(21) Appl. No.: 18/910,347

(22) Filed: Oct. 9, 2024

(51) Int. Cl. A47J 37/12; B01D 29/13; B01D 29/96

(52) U.S. Cl. CPC A47J 37/1223; A47J 37/1271; B01D 29/13; B01D 29/96

(57) ABSTRACT

The present disclosure teaches a device for the filtration and transportation of used cooking oil (UCO). The presently disclosed device uses a two-stage filtration system, comprising a basket filter and a reusable SS (stainless steel) filter. After the filtration, the UCO may be discharged back to the fryer or a UCO dumpster via a wand. The selection of a reusable SS filter ensures durability, reusability, and ease of cleaning compared to state-of-the-art cellulose filters. The presently disclosed device uses a rechargeable battery-powered pump to deliver the UCO from the basket filter to the reusable SS filter, which eliminates the use of charging cords, thus allowing maneuverability and eliminating trip hazards in the often-chaotic food preparation environment. The presently disclosed device also includes a platform with wheels for the transportation of the UCO in a food preparation service environment and to the UCO dumpster.

### TECHNICAL FIELD

The present disclosure relates to waste management, filtration technology, and sustainable design.

### BACKGROUND

Processing and transportation of used cooked oil (UCO) is an important issue in the food service and restaurant industry. Filtering could extend the usable life of the oil, thus reducing costs and potential environmental pollution caused by the UCO. Most Many fryers do not have built-in oil filtration systems to filter the oil. State of-the art Portable oil filtration systems (POFS) available today, designed solely for interior environments, are not designed to allow transporting the UCO to exterior dumpsters when the oil is no longer usable. They are not designed for easy maneuverability and require plug-in electric pumps with long extension cords, which are inconvenient and increases the risk of trip hazards in an often-chaotic food service or restaurant environment. Moreover, their filtration components, which are usually cellulose filters, are not reusable nor durable, which creates waste and incurs additional costs and manual labor. Also, cellulose filters require a higher head pressure than most battery-powered pumps can provide, so start-of-the-art filtration systems using cellulose filters may have to include an extension cord, which, as discussed above, is an undesirable feature in a food preparation environment.

To address the above-discussed problems, the presently disclosed technology teaches a POFS that could provide: (1) safe and effective UCO transport; (2) reusable filters; and (3) a rechargeable, battery-powered pump, which eliminates the need to have extension cords.

### SUMMARY

The present disclosure teaches a device for filtration and transportation of used cooking oil (UCO), comprising: a shuttle tank; an upper chamber located above the shuttle tank, housing a filter chamber and a rechargeable-battery powered pump, wherein the filter chamber is connected to the shuttle tank through a tube; a basket filter, placed in the shuttle tank, for a first-stage filtration of used cooking oil (UCO); a reusable SS (stainless steel) filter, placed in the filter chamber, for a second-stage filtration of the UCO; the rechargeable-battery powered pump, for pumping the UCO from the shuttle tank to the filter chamber through the tube; a platform with wheels, on which the shuttle tank is mounted, for transporting the UCO; a wand connected to the filter chamber, for discharging the UCO.

In some embodiments, the shuttle tank has an declined bottom toward a front of the shuttle tank.

In some embodiments, the device also comprises a cradle attached to a side of the shuttle tank, for a head of the wand to rest in.

In some embodiments, the device further comprises a cart handle, for a user to hold onto while transporting the device.

In some embodiments, the shuttle tank and the upper chamber are made of aluminum.

In some embodiments, the platform is made of aluminum.

In some embodiments, the basket filter includes two layers.

In some embodiments, the reusable SS filter has a hole size of 40 to 100 microns, depending on a level of filtration desired and a contaminant level of the UCO.

In some embodiments, a sheet of textured material is wrapped around a section of the wand, functioning as a wand handle, in order to hold the wand without contacting the tube which is hot from the flowing oil.

In some embodiments, the upper chamber is secured to the shuttle tank via one or more connecting pieces.

In some embodiments, the platform has two wheels on the side underneath the cart handle, enabling the platform to be tilted.

In some embodiments, the two wheels have a diameter equal to or larger than 8 inches, enabling the device to traverse standard staircases.

In some embodiments, the wand includes a gate or a valve, controlling a flow of the UCO.

In some embodiments, the device further comprises the UCO cooled down to 250° Fahrenheit in the shuttle tank.

The presently disclosed technology also teaches a method for filtering and transporting used cooking oil (UCO), comprising: adding used cooking oil (UCO) to the shuttle tank; filtering the UCO with a basket filter located in the shuttle tank; pumping the UCO from the shuttle tank to a filter chamber, housed in an upper chamber located above the shuttle tank, and connected to the shuttle tank via a tube, using a rechargeable battery-powered pump; filtering the UCO with a reusable SS filter located in the filter chamber; discharging the UCO with a wand connected to the filter chamber; placing the wand in a cradle connected to a side of the shuttle tank.

In some embodiments, the method also includes: transporting the UCO from a first food preparation station to a second food preparation station or a UCO dumpster, using a platform with wheels, on which the shuttle tank is mounted.

In some embodiments, the discharging of the UCO is to a fryer or a UCO dumpster.

In some embodiments, the reusable SS filter has a hole size of 40 to 100 microns, depending on a level of filtration desired and a contaminant level of the UCO.

In some embodiments, the shuttle tank has an inclined bottom toward a front of the shuttle tank.

In some embodiments, the UCO is cooled down to 250 Fahrenheit before being added to the shuttle tank.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1 is a block diagram illustrating the 2-stage filtration process performed by some embodiments of the presently disclosed technology.

FIG. 2 is an isometric diagram illustrating the structure of a device for the filtration and transportation of used cooking oil, according to some embodiments of the presently disclosed technology;

FIG. 3 is a diagram illustrating a work environment in which the device for filtration and transportation of used cooking oil may operate, according to some embodiments of the presently disclosed technology.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

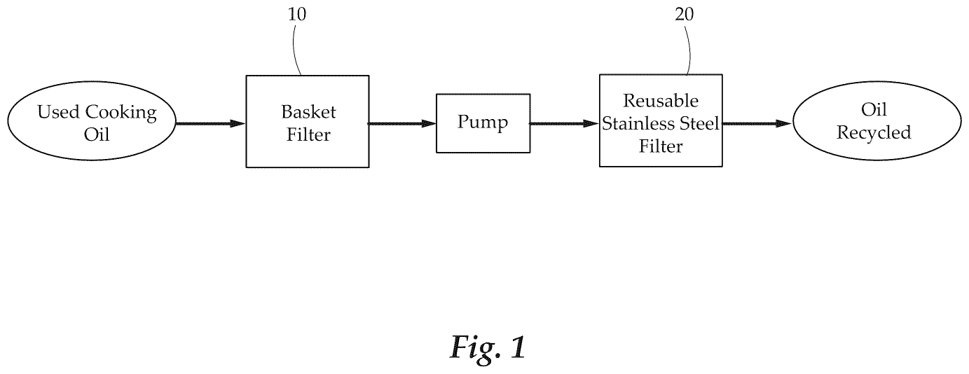

FIG. 1 is a block diagram illustrating the 2-stage filtration process performed by some embodiments of the presently disclosed technology. At 10, used cooking oil (UCO) goes through a basket filter 101 and completes the first stage of filtration. In some embodiments, the basket filter 101 may further comprise two sub-stages of filtration, which will be discussed in the later sections in detail. At 20, the UCO processed by the basket filter 101 gets pumped to a reusable SS (stainless steel) filter 103, goes through the reusable SS filter, and completes the second stage of filtration. The 2-stage filtration process results in recycled oil.

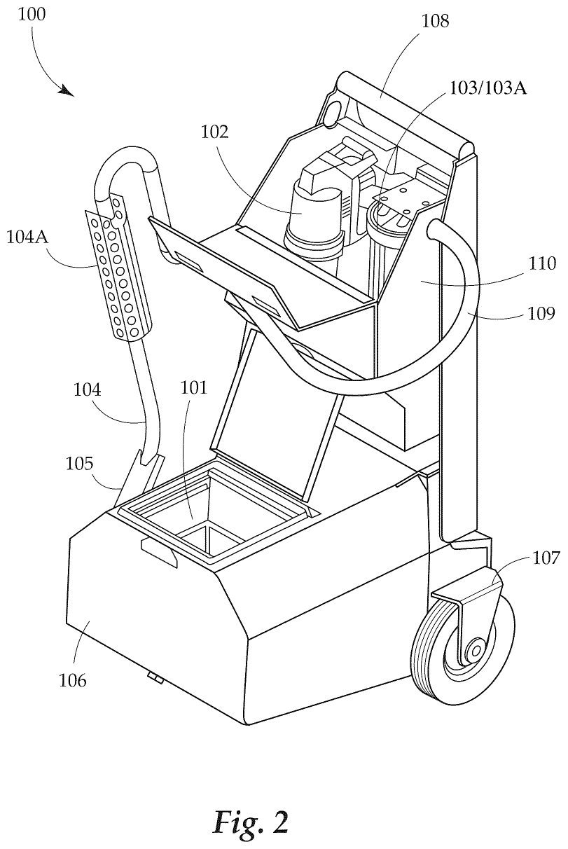

FIG. 2 is an isometric diagram illustrating the structure of a device for the filtration and transportation of used cooking oil, according to some embodiments of the presently disclosed technology.

In some embodiments, the presently disclosed device 100 may implement a two-step filtering process. The first filter may be a basket filter (also called a strainer or a basket screen) 101, contained in a shuttle tank 106. In some embodiments, the shuttle tank 106 may be made of aluminum, given that aluminum is a corrosion-resistant, easy-to-clean, and lightweight material. In some embodiments, the shuttle tank 106 may include an opening on the top, and the opening may have a cover to prevent dust and other debris from entering the shuttle tank. In some embodiments, the basket filter 101 may collect large particulates of waste from UCO poured into the shuttle tank 106. This process of collecting large particulates of waste could prevent the large particulates from clogging the pump 102 or the reusable SS filter 103, which will be discussed in detail in the later paragraphs. In some embodiments, the basket filter 101 may be a perforated or mesh screen. In some embodiments, the opening size of the perforated or mesh screen for the basket filter 101 may be optimized. If the opening size is too large, too much waste may be pumped to the second filter, which plugs the second filter too quickly. On the other hand, if the opening size is too small, the UCO may flow too slowly through the basket filter 101 and may starve the pump 102, which may also make the device 100 take too long to complete the filtering process. In some embodiments, the shuttle tank 106 and the basket filter 101 may be located on a lower part of the device 100, so that the shuttle tank may be lower than a typical fryer used at a food preparation station, in order to facilitate the process of pouring UCO into the shuttle tank and minimize safety hazards. In some embodiments, the basket filter 101 may be made of stainless steel for chemical resistance, endurance, and ease of cleaning. In some embodiments, the basket filter 101 may be removable from the shuttle tank 106. In some embodiments, the basket filter 101 may be reusable. In some embodiments, the device 100 may include a plurality of removable and interchangeable basket filters 101 with various specifications, for different uses. In some embodiments, the shuttle tank 106 may have a bottom tilting toward the front of the shuttle tank, so that the UCO may pool in the direction of the front of the shuttle tank 106. In some embodiments, the device 100 may include a tube that connects to the suction (bottom) of the pump 102 that collects the oil from the bottom front of the shuttle tank 106, allowing the pump to process nearly all the UCO.

In some embodiments, the basket filter 101 may be a 2-layer basket filter, comprising two sub-stages of filtration. The UCO may first flow through a larger mesh of the top screen layer of the basket filter 101, and then flow through a smaller mesh of the bottom screen layer of the basket filter. There may be ≈1″ gap of space between the two layers created by an internally raised platform as a part of the top screen layer. The top screen layer may be removable and may fit into the basket filter 101 with the internally raised platform of the top screen layer placed on top of the bottom screen layer. This design could (1) optimize the opening sizes of the meshes, and (2) increase the time for the UCO to flow through the basket filter 101 to protect the reusable SS filter 103 from getting plugged too quickly with an excessive amount of larger particulates.

In some embodiments, the device 100 may include a pump 102 for transporting the UCO from the basket filter 101 to the second filter located on an upper part of device 100, which may be a reusable SS filter 103 and will be discussed in detail in the later paragraphs. In some embodiments, the pump 102 may be rechargeable-battery-powered, which, as discussed in the background section, (1) allows maneuverability of the device 100, so that the filtration device can double as a transportation device, which saves time and labor in a food preparation environment, and (2) eliminates the need for having an extension cord, which is cumbersome and may be a trip hazard in the often-chaotic food preparation environment. In some embodiments, the UCO processed by the basket filter 101 may be transported to the reusable SS filter 103 via a tube 109. In some embodiments, the tube 109 may be vertical or S-shaped, stiff or flexible. In some embodiments, the power of the pump 102 may be adjusted according to the specifications of the basket filter 101 and the reusable SS filter 103, the specifications of the rechargeable battery powering the pump, and the volume of UCO processed by the device 100. In some embodiments, the device 100 may include a controller that allows a user to adjust the power of the pump 102. In some embodiments, the pump 102 may be turned on/off by the controller, a button, or a switch.

In some embodiments, the device 100 may include a reusable SS (stainless steel) filter 103 to remove fine particles from the UCO. As the name suggests, the reusable SS filter 103 may be made of stainless steel, which is durable, reusable, resistant to various chemicals, and easily cleanable. Hence, unlike the cellulose filters used in state-of-the-art UCO filtration systems, as discussed in the background section, which are neither durable nor significantly reusable, the reusable SS filter 103 is easily cleanable and can last for a long time, which saves both costs and manual labor. Also, as discussed in the background section, cellulose filters require a higher head pressure than most battery-powered pumps can provide. Hence, using reusable SS filters instead of cellulose filters also enables the presently disclosed device to be designed as battery-charged, which as discussed above, allows for maneuverability. In some embodiments, the reusable SS filter 103 may have a hole size of 40 to 100 microns, depending on a level of filtration desired and a contaminant level of the UCO.

In some embodiments, the reusable SS filter 103 may be placed in a filter chamber 103A in the device 100. In some embodiments, the filter chamber 103A may be cylindrical. In some embodiments, the UCO may be pumped from the shuttle tank 106 to the filter chamber 103A via the tube 109, then the UCO may enter the wand 104 after the second stage of filtering by the reusable SS filter 103 in the filter chamber. In some embodiments, both the filter chamber 103A and the pump 102 may be located in an upper chamber 110. In some embodiments, the upper chamber 110 may have an opening on its top, and the opening may have a cover to prevent dust and debris from entering the upper chamber. In some embodiments, the upper chamber 110 may be above shuttle tank 106 and located on an upper part of the device 100, which may facilitate the dischargement of the filtered oil from the wand 104 (since oil needs to move downward through the wand during the dischargement). It is worth noticing that gravity is only helpful in discharging the oil through the wand 104 when emptying the wand after the pump 102 is turned off; otherwise, the pressure from the pump may play the primary role in driving the oil through the wand. In some embodiments, the filter chamber 103A, housed in the upper chamber 110, may connect to the shuttle tank 106 through the tube 109. In some embodiments, the upper chamber 110 may be secured to the shuttle tank 106 via one or more connecting pieces for structural support and reinforcement. In some embodiments, the reusable SS filter 103 may be removable and replaceable. In some embodiments, the entire filter chamber 103A containing the reusable SS filter 103 may also be removable and replaceable.

In some embodiments, the device 100 may include a wand 104, to discharge the filtered oil back to the fryer, to the shuttle tank 106 for a second round of filtering, or to a UCO dumpster 300. In some embodiments, the wand 104 may not include a gate or valve, and the dischargement of filtered oil may simply be controlled by turning the pump 102 on or off. Alternatively, in some embodiments, the wand 104 may include a gate or valve controlling the dischargement of the filtered oil, and the gate or valve may be controlled by a button, a switch, or a controller. In some embodiments, the wand 104 may contain a second tube and a head. In some embodiments, the entirety or one or more parts of the second tube may be flexible. In some embodiments, the head may be rigid. In some embodiments, the second tube may include a wand handle 104A for the user to hold while using the wand 104. In some embodiments, the wand handle 104A may be implemented as a piece of stiff and textured material wrapped around a section of the wand 104. In some embodiments, the wand handle 104A may be implemented as including a textured and stiff section in the wand 104A. In some embodiments, the wand handle 104A may be made of a material with low heat conductivity, which protects the operator from the high temperature of the filtered oil. In some embodiments, the device 100 may further include a cradle 105 located on a side of the shuttle tank 106 for the head of the wand 104 to rest in while the device is not in use.

In some embodiments, the device 100 may include a platform 107, supporting the shuffle tank 106. In some embodiments, the platform 107 may be made of aluminum, a lightweight metal. In some embodiments, the platform 107 may include one or more wheels, so that the device 100 may be transported from food stations 100 to the UCO dumpster 300, which is usually located outdoors. In some embodiments, the device 100 may also include a cart handle 108, so that a user may hold onto the handle while transporting the device 100. In some embodiments, the cart handle 108 may be on a side of the pump 102. In some embodiments, the platform 107 may include two wheels parallel to and directly under the handle 108, allowing the device to traverse uneven grounds when tilted. In some embodiments, the two wheels may have a diameter equal to or larger than 8 inches, so that the device 100 may comfortably traverse typical staircases, which may have a step height (rise) of about 7 to 8 inches. Also, the two wheels may elevate a back of the shuttle tank 106, which, as discussed above, causes the shuttle tank 106 to have an inclined bottom that allows the UCO to pool in a front of the shuttle tank 106, where the tube connected to the suction of the pump ends.

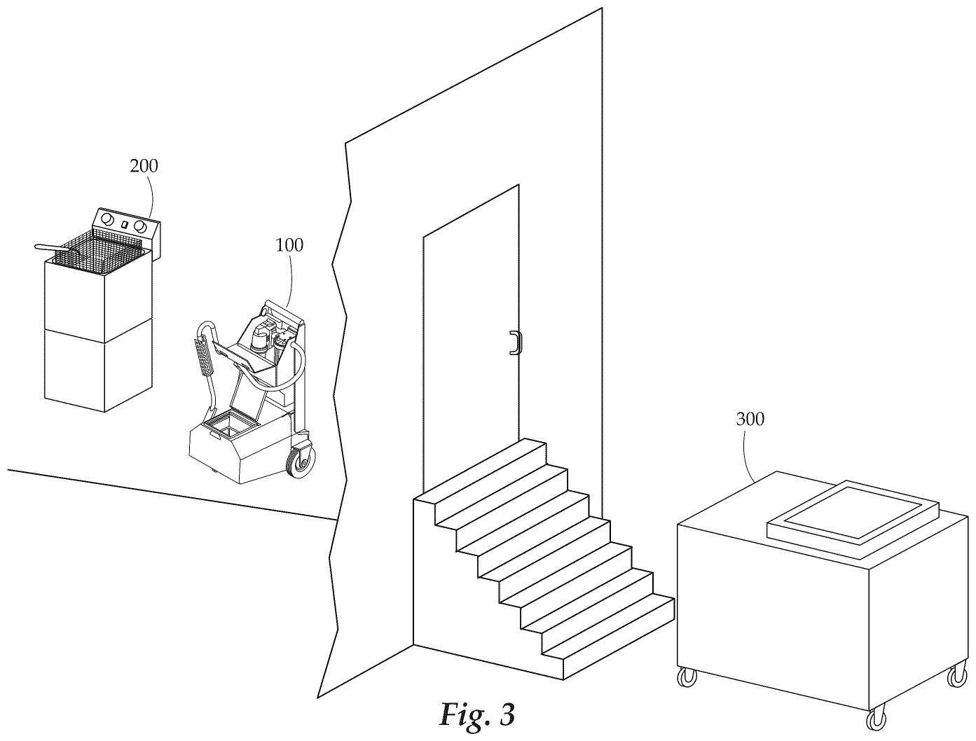

FIG. 3 is a diagram illustrating a work environment in which the device for filtration and transportation of used cooking oil may operate, according to some embodiments of the presently disclosed technology.

In some embodiments, the UCO may be poured from a fryer from the food station 200 to the device 100 for further processing. In some embodiments, The UCO may be emptied from the fryer by opening a manual drain valve on the bottom front of the fryer to pour the UCO through the basket filter 101. In some embodiments, the UCO may be cooled to 250 Fahrenheit before being poured into the device 100. Cooling the UCO down to 250 Fahrenheit may help to prevent excessive strain upon an impeller of the pump 102. It may also reduce the risks of burning an operator if the operator used the device 100 in an unintended manner. In some embodiments, the UCO may pass through the basket filter 101 to start the first stage of the filtering process. In some embodiments, a user may turn the pump 102 on to transfer the UCO, that passed through the basket filter 101 and into tank, to the reusable SS filter 103, to start the second stage of the filtering process. After the UCO passes the reusable SS filter 103, the filtered UCO may be discharged back to the fryer, or back to the shuttle tank for another round of processing. In some embodiments, the oil may be reusable after over six times of filtering. In some embodiments, the device 100 may be transported by the operator from one food station to another food station. In some embodiments, the device 100 may be transported by the operator from the food station 200 to the UCO dumpster 300, which is usually located outdoors, and the filtered UCO may be discharged to the UCO dumpster 300 via the wand 104.

Furthermore, unless explicitly stated in the claims, the use of order, numbers, letters, or other names for processing elements and sequences are not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of +20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A device for filtration and transportation of used cooking oil (UCO), comprising:
a shuttle tank;
an upper chamber located above the shuttle tank, housing a rechargeable-battery powered pump and a filter chamber, wherein the filter chamber connects to the shuttle tank through a tube;
a basket filter, placed in the shuttle tank, for a first-stage filtration of used cooking oil (UCO);
a reusable SS (stainless steel) filter, placed in the filter chamber, for a second-stage filtration of the UCO;
the rechargeable-battery powered pump, for pumping the UCO from the shuttle tank to the filter chamber through the tube;
a platform with wheels, on which the shuttle tank is mounted, for transporting the UCO;
a wand connected to the filter chamber, for discharging the UCO.

2. The device in claim 1, wherein the shuttle tank has an inclined bottom toward a front of the shuttle tank.

3. The device in claim 1, further comprising a cradle attached to a side of the shuttle tank, for a head of the wand to rest in.

4. The device in claim 1, further comprising a cart handle, for a user to hold onto while transporting the device.

5. The device in claim 1, wherein the shuttle tank and the upper chamber are made of aluminum.

6. The device in claim 1, wherein the platform is made of aluminum.

7. The device in claim 1, wherein the basket filter includes two layers.

8. The device in claim 1, wherein the reusable SS filter has a hole size of 40 to 100 microns, depending on a level of filtration desired and a contaminant level of the UCO.

9. The device in claim 1, wherein a sheet of textured material is wrapped around a section of the wand, functioning as a wand handle.

10. The device in claim 1, wherein the upper chamber is secured to the shuttle tank via one or more connecting pieces.

11. The device in claim 4, wherein the platform has two wheels on a side of the cart handle, enabling the platform to be tilted.

12. The device in claim 11, wherein the two wheels have a diameter equal to or larger than 8 inches, enabling the device to traverse standard staircases.

13. The device in claim 1, wherein the wand includes a gate or a valve, controlling a flow of the UCO.

14. The device in claim 1, furthering comprising the UCO cooled down to 250 Fahrenheit in the shuttle tank.

15. A method for filtering and transporting used cooking oil (UCO), comprising:
adding used cooking oil (UCO) to the shuttle tank;
filtering the UCO with a basket filter located in the shuttle tank;
pumping the UCO from the shuttle tank to a filter chamber, housed in an upper chamber located above the shuttle tank, and connected to the shuttle tank via a tube, using a rechargeable battery-powered pump;
filtering the UCO with a reusable SS filter placed in the filter chamber;
discharging the UCO with a wand connected to the filter chamber;
placing the wand in a cradle connected to a side of the shuttle tank.

16. The method in claim 15, further comprising:
transporting the UCO from a first food preparation station to a second food preparation station or a UCO dumpster, using a platform with wheels, on which the shuttle tank is mounted.

17. The method in claim 15, wherein the discharging of the UCO is to a fryer or a UCO dumpster.

18. The method in claim 15, wherein the reusable SS filter has a hole size of 40 to 100 microns, depending on a level of filtration desired and a contaminant level of the UCO.

19. The method in claim 15, wherein the shuttle tank has an inclined bottom toward a front of the shuttle tank.

20. The method in claim 15, wherein the UCO is cooled down to 250 Fahrenheit before being added to the shuttle tank.
